(19) United States
(12) Patent Application Publication
(10) Pub. No.: US 2017/0190065 A1
(43) Pub. Date: Jul. 6, 2017

(54) ERGONOMIC SHAVING RAZOR

(71) Applicant: Kelly Pound, Longmont, CO (US)

(72) Inventor: Kelly Pound, Longmont, CO (US)

(21) Appl. No.: 14/987,110

(22) Filed: Jan. 4, 2016

(51) Int. Cl. B26B 21/52; B26B 21/40; B26B 21/44

(52) U.S. Cl. CPC B26B 21/522; B26B 21/44; B26B 21/4037

(57) ABSTRACT

An ergonomic shaving razor is provided. The razor includes a body member having an ergonomic shaped outer surface and a recess on an opposing side of the outer surface. The razor also includes a first gripping member and a second gripping member, wherein the first and second gripping members are coupled on opposing sides of the outer surface of the body member. The razor may also include a blade receiving member coupled on an end of the body member, wherein the blade receiving member releasably receives and retains a blade cartridge. The razor has a container having an inner volume and an opening providing access to the inner volume. The razor also includes a retaining member having an aperture coupled to the body member, wherein the retaining member retains the container within the recess of the body member and the aperture provides access to the inner volume of the container.

### BACKGROUND OF THE INVENTION

Technical Field

This invention relates generally to a razor for shaving and more particularly to an ergonomic device for holding a shaving razor with storage and delivery of skin preparations.

State of the Art

The use of razors for shaving is always a present need. Women often utilize razors to shave legs, under arms and the like. Typically this is performed in a shower or bathtub. Soap or some sort of shaving preparation is often applied on the skin prior to shaving using a sponge scrub, cloth, a hand, applicator and exfoliating devices and the like. A razor is typically stored on a side of a bathtub or in some other storage shelf or storage device.

These conventional razors require the shaving preparation to be stored in the bathtub or shower and are also aesthetically displeasing. Further, the razors are often stored with the blades down and in contact with a surface, thereby reducing the life of the razor, as well as placing the blades in a more unsanitary location. Additionally, application and/or exfoliating means for applying shaving preparations, such as, but not limited to a sponge, a scrub, a cloth and the like also suffer from unsanitary locations, such as the side of a tub and the like. Further, conventional razors also lack an ergonomic grip with ease of use.

Accordingly, there is a need in the field of shaving razors for an improved shaving razor that overcomes at least these limitations of conventional shaving razors.

### SUMMARY OF THE INVENTION

The present invention relates to an ergonomic shaving razor. The ergonomic shaving razor may include a body member having an ergonomic shape, wherein the body member receives and retains a blade and receives a shaving skin preparation device.

An embodiment includes an ergonomic device for holding shaving razor comprising a body member having an ergonomic shape; a first gripping member and a second gripping member, wherein the first and second gripping members are coupled on opposing sides of the body member; and a blade receiving member coupled on an end of the body member, wherein the blade receiving member releasably receives and retains a blade.

Another embodiment includes an ergonomic device for holding a shaving razor comprising a body member having an ergonomic shaped outer surface and a recess on an opposing side of the outer surface; a first gripping member and a second gripping member, wherein the first and second gripping members are coupled on opposing sides of the outer surface of the body member; a blade receiving member coupled on an end of the body member, wherein the blade receiving member releasably receives and retains a blade; a container removably coupled within the recess of the body member; and a retaining member coupled to the body member, wherein the retaining member retains the container within the recess of the body member.

Yet another embodiment includes an ergonomic device for holding a shaving razor comprising a body member having an ergonomic fish shaped outer surface and a recess on an opposing side of the outer surface; a first gripping member shaped like a dorsal fin and a second gripping member shaped like a pelvic fin, wherein the first and second gripping members are coupled on opposing sides of the outer surface of the body member; a blade receiving member shaped like a tail coupled on an end of the body member, wherein the blade receiving member releasably receives and retains a blade; a container having an inner volume and an opening providing access to the inner volume, the container removably coupled within the recess of the body member; and a retaining member having an aperture coupled to the body member, wherein the retaining member retains the container within the recess of the body member and the aperture provides access to the container.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of an ergonomic device for holding a shaving razor in accordance with embodiments of the present invention;

FIG. 2 is a front view of an ergonomic device for holding a shaving razor in accordance with embodiments of the present invention;

FIG. 3 is a rear view of an ergonomic device for holding a shaving razor in accordance with embodiments of the present invention;

FIG. 4 is a right side view of an ergonomic device for holding a shaving razor in accordance with embodiments of the present invention;

FIG. 5 is a bottom view of an ergonomic device for holding a shaving razor in accordance with embodiments of the present invention;

FIG. 6 is an exploded perspective view of an ergonomic device for holding a shaving razor in accordance with embodiments of the present invention;

FIG. 7 is another exploded perspective view of an ergonomic device for holding a shaving razor in accordance with embodiments of the present invention; and

FIG. 8 is a perspective view of an ergonomic device for holding a shaving razor with a disposable razor retained therein in accordance with embodiments of the present invention.

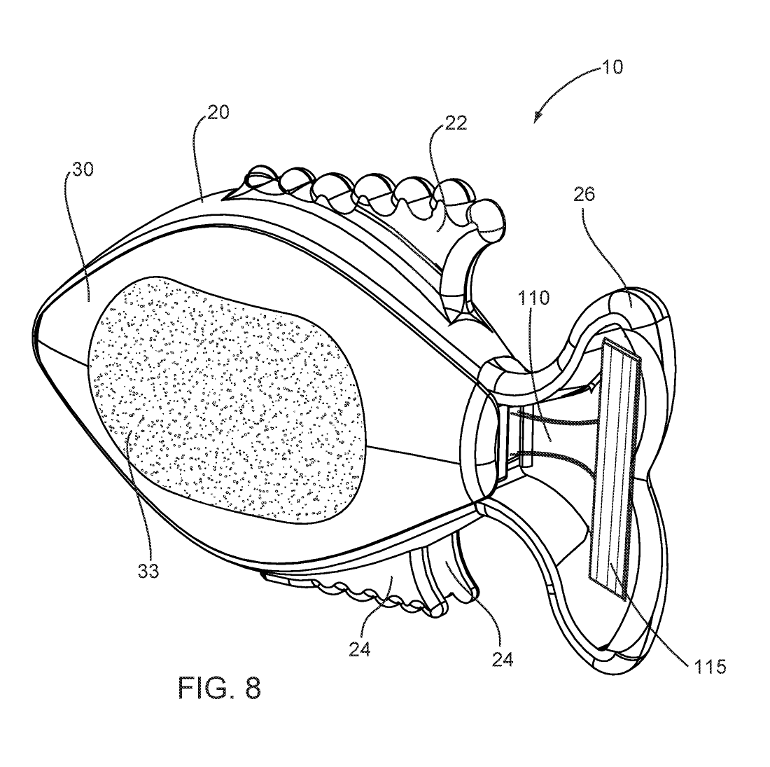

### DETAILED DESCRIPTION OF EMBODIMENTS OF THE INVENTION

As discussed above, embodiments of the present invention relate to an ergonomic device for holding a shaving razor. The ergonomic device may include a body member having an ergonomic shape, wherein the body member receives and retains a blade and operatively receives a shaving skin preparation.

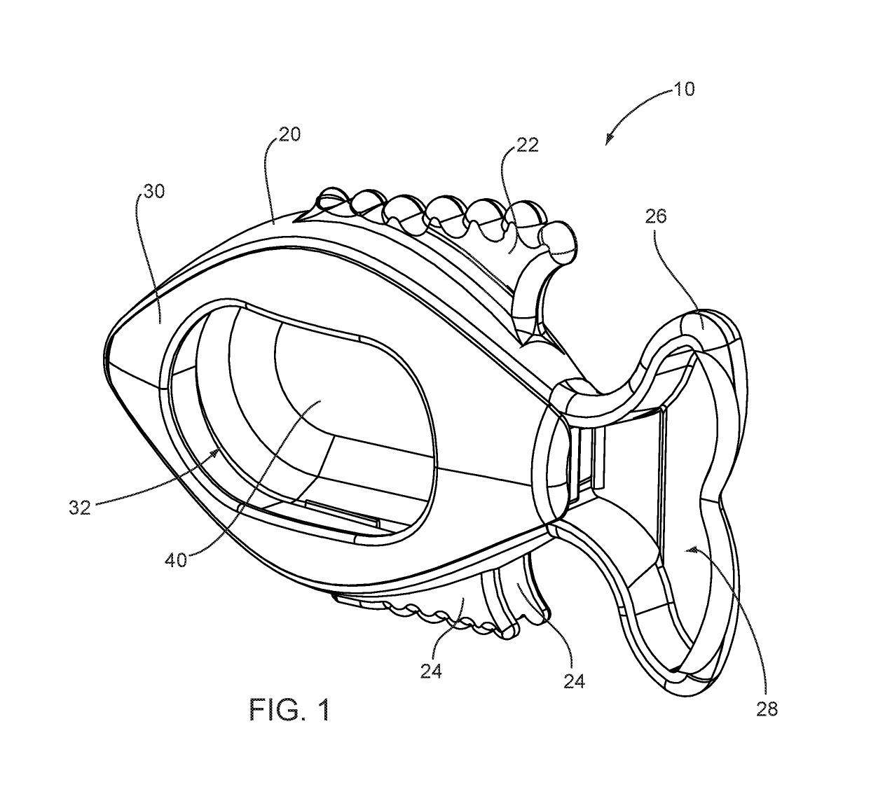

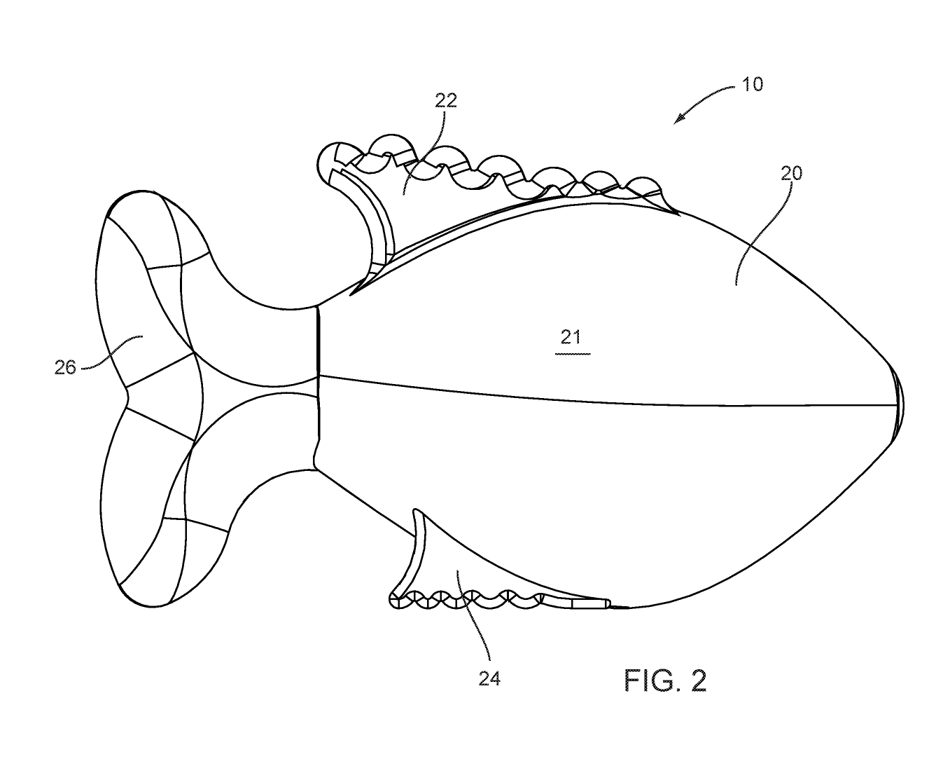

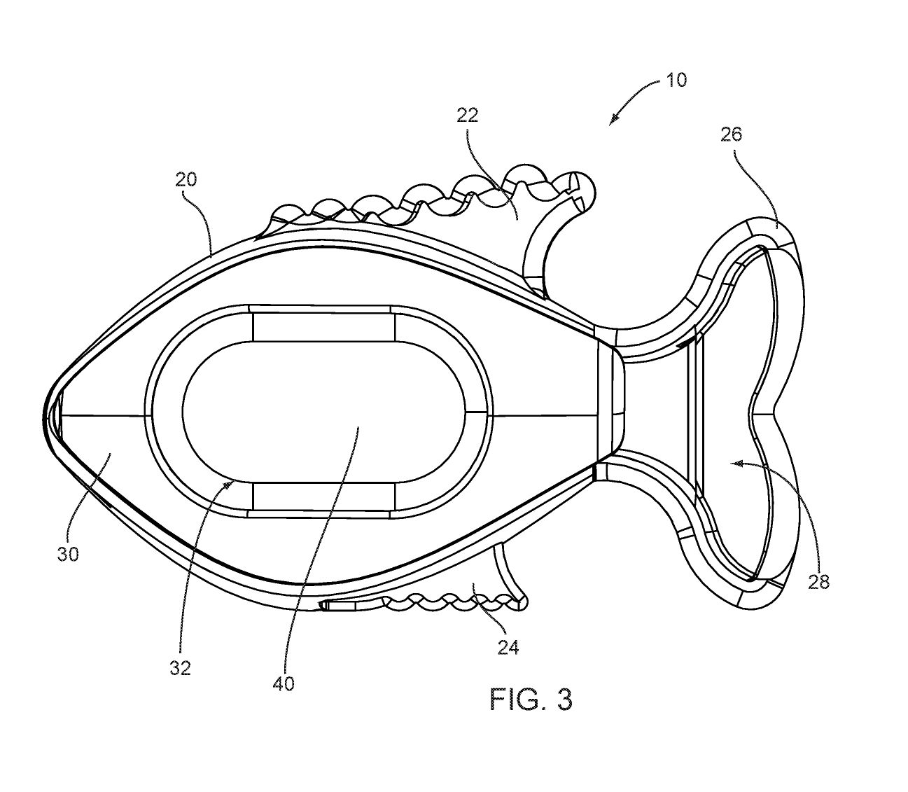

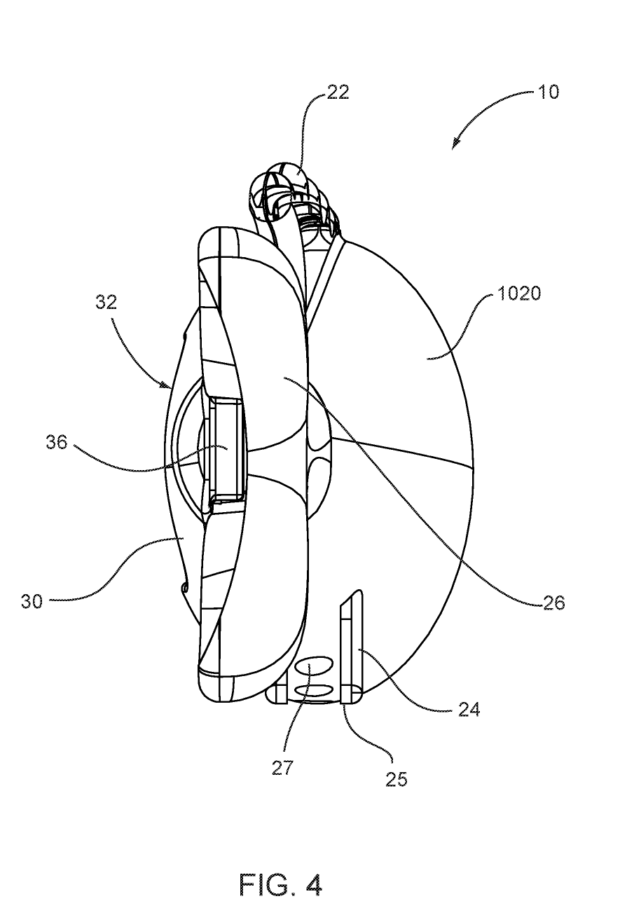

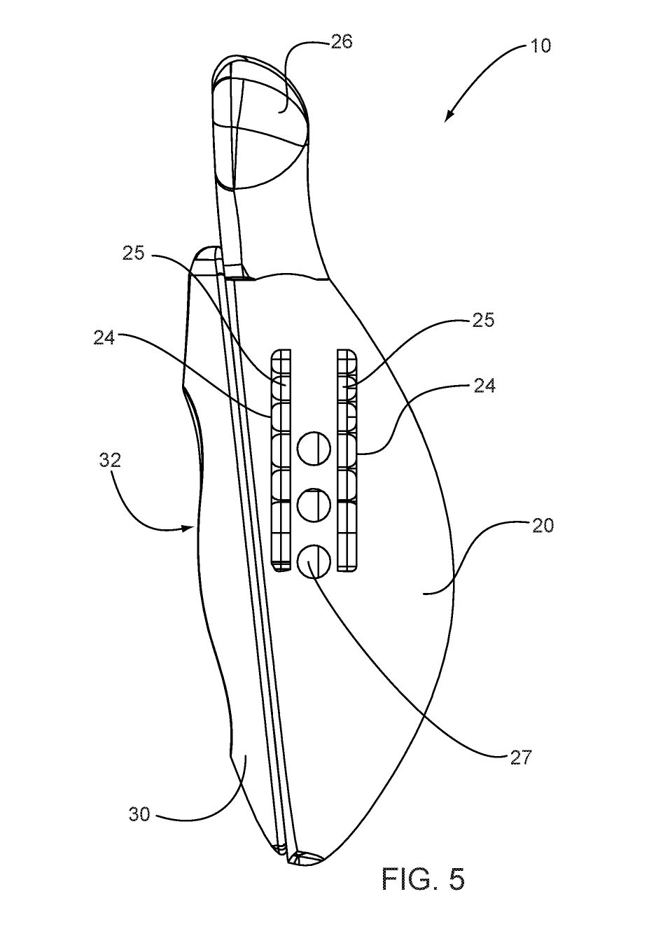

Referring to the drawings, FIGS. 1-7 depict an ergonomic device 10 for holding a shaving razor in accordance with embodiments. Ergonomic device 10 for holding a shaving razor may comprise a body member 20, a retaining member 30 and a container 40. Retaining member 30 is releasably coupled to body member 20. In embodiments, container 40 and any contents within container 40 may be coupled within body 20 between body member 20 and retaining member 30.

According to embodiments, body member 20 may include an ergonomic outer surface 21, a first gripping member 22, a second gripping member 24, and a blade receiving member 26. Body member 20 may also include a recess 29 and a blade recess 28 located in the blade receiving member 26. Ergonomic outer surface 21 may be shaped to conform to a palm of a user's hand. In other words, outer surface 21 may be a curved and rounded shape. First gripping member 22 and second gripping member 24 may be coupled on opposing sides of ergonomic outer surface 21. In this configuration, a user's thumb may engage first gripping member 22 and other fingers may engage second gripping member 24, or a user's thumb may engage second gripping member 24 and other fingers may engage first gripping member 22, depending on what hand a user operates the device 10 with. Additionally, second gripping member 24 may function as a base for display purposes. For example, second gripping member 24 may support ergonomic device 10 in a display position on a surface by use of support surface 25.

Recess 29 within body member 20 is located on an opposing side from ergonomic outer surface 21. Recess 29 may be configured to receive container 40 therein. Once container 40 is within recess 29, retaining member 30 may be coupled to body member 20 and engage container 40 and any contents therein to retain container 40 and its contents within recess 29.

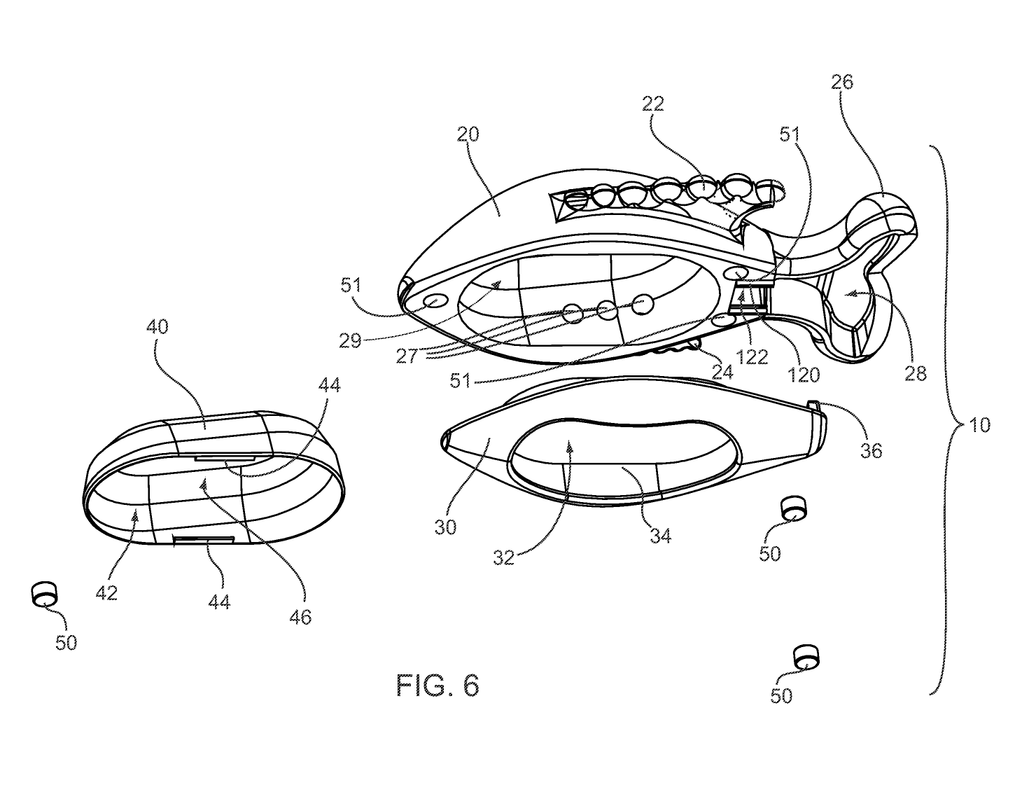

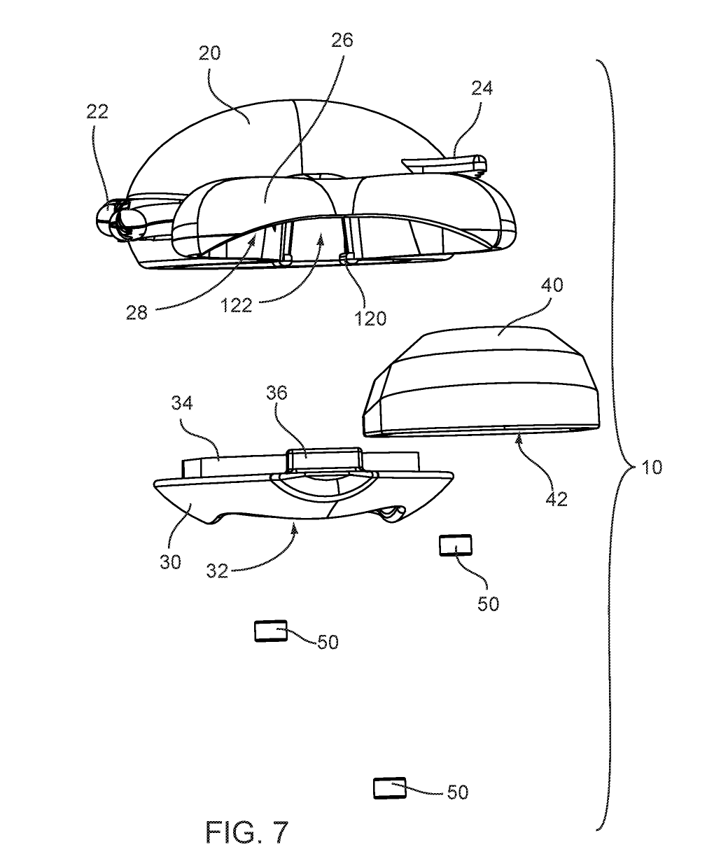

Blade recess 28 may be formed in blade receiving member 26. Blade recess 28 includes a shape for receiving a replaceable razor blade 115 within blade recess 28. The replaceable razor blade may be removably secured within blade recess 28 using known techniques. Blade 115 may also include a disposable razor, wherein the body member 20 is configured to releasably receive and retain the handle 110 of the disposable razor for use in the ergonomic device 10, wherein the handle 110 extends into opening 122 and retained by protrusions 120 as shown in FIGS. 6 and 7. It will be understood that the disposable razor in some embodiments may include a handle that is shorter than a conventional disposable razor. This shortened handle portion allows the disposable razor to easily fit with the device 10. The shortened handle portion provides a more eco-friendly product with less waste. In some embodiments, blade 115 may include a blade cartridge, such as a disposable blade cartridge.

Body member 20 may be in a form of an animal or other object. For example, and without limitation, body member 20 as shown in FIGS. 1-7 is shaped like fish. In this embodiment, ergonomic outer surface 21 may have a shape of a body of a fish. First gripping member 22 may have a shape of a dorsal fin. Second gripping member 24 may have a shape of a pelvic fin. Blade receiving member 26 may have a shape of a tail of a fish. A fish shaped ergonomic device 10 improves the aesthetic appeal of device 10 by making it an artistic piece that may be stored on a surface to show the fish shape while hiding the blade and other components. While is it shown in the drawing figures that body member 20 may be a shape of a fish, it is understood that other types of shapes may be used, while accomplishing the same functionality. For example and without limitation, the shape of body member 20 may be an oval, an owl or bird with a tail, a mermaid, a turtle, a seahorse, a seashell, a pony, and the like.

Retaining member 30, in accordance with embodiments, may include an aperture 32 extending through retaining member 30. Retaining member 30 may also include a protrusion 34, wherein aperture 32 extends through protrusion 34. In this embodiment, protrusion 34 establishes a perimeter of aperture 32. The perimeter of protrusion 34 corresponds to the shape of recess 29 of body member 20, wherein protrusion 34 engages an inner surface of recess 29 of body member 20 when retaining member 30 is removably coupled to body member 20. Aperture 32 provides access to recess 29 in body member 20.

Retaining member 30 may be coupled to body member 20 by use of magnets 50 retained within holes 51 of body member 20, wherein retaining member 30 may include a material that is attracted to magnets, such as a ferrous material or the like. Other means of coupling retaining member 30 to body member 20 are contemplated, such as, but not limited to clips, clasps, snaps, screws, bolts, rods, and the like. Further still, the retaining member 30 may be a hingedly coupled one side to a corresponding side of the body member 20 and the retaining member 30 may a closure device on the opposing side to releasably couple to a corresponding opposing side of the body member 20. In this configuration the retaining member 30 and the body member 20 form a clam shell type connection allowing the retaining member 30 to be rotated away from the body member 20 in order to provide access to the recess 29 and for replacement of the blade 115.

Retaining member 30 may also include blade protrusion 36. Blade protrusion 36 may engage a handle 110 or blade retaining device to maintain the blade retaining device within the blade recess 28 and opening 122. Blade protrusion 36 may work in conjunction with protrusion 120 to retain blade 115 within blade receiving member 26. In the embodiment shown in the drawings, opening 122 is formed in blade receiving member 26. It is contemplated that in other embodiments, opening 122 may be exposed with a gap between body member 20 and blade receiving member 26.

Container 40 may include an opening 42 that provides access to an inner volume 46. Inner volume 46 may receive a shaving skin preparation therein. A shaving skin preparation may include soap, shaving cream container, moisturizer and the like. Container 40 may also include retaining protrusions 44, wherein protrusions 44 retain the shaving skin preparation within inner volume 46 of container 40.

In use, the shaving skin preparation may be inserted within inner volume 46 of container 40 through opening 42. Retaining protrusion 44 operate to engage the shaving skin preparation and releasably retain the shaving skin preparation within inner volume 46. Container 40 with the shaving skin preparation coupled thereto may be inserted within recess 29 of body member 20 with the shaving skin preparation extending away from body member 20. Retaining member 30 may then be coupled to body member 20, wherein retaining member engages container 40 and the coupling of retaining member 30 to body member 20 retains container within recess 29 of body member 20. Aperture 32 may include an exfoliating device 33, such as sponge or loofah. A user may then remove retaining member 30 to access the shaving skin preparation and apply the shaving skin preparation to an area of the body that the user desires to shave. The user may then use the exfoliating device 33 to scrub the user's skin in areas where exfoliation or scrubbing is desired.

While it is shown that retaining member 30 includes aperture 32 to provide access to container 40 within body member 20, some embodiments may include retaining member 30 without an aperture 32. Further, while it has been discussed that container 40 may retain a shaving skin preparation, it may also receive and retain an exfoliation insert, including, but not limited to a natural or artificial brush or sponge, a loofah, a puff, or any other exfoliating product. Additionally, the shaving skin preparation previously discussed may be a soap bar type of skin preparation or a liquid shaving skin preparation that is held in a pod and can be pumped through a tube and applied to the skin of a user as the blade to apply the skin preparation just prior to the blade shaving the hair on the skin. This tube may extend through a handle portion of a blade retaining device.

Because of the ergonomic shape of device 10, such as a countered or convex surface for corresponding to a shape of a user's palm, a user may use the natural wrist motion in order to pivot the blade to shave around contoured body parts, such as a leg, knee, or underarm.

Additionally during use of ergonomic device 10, second gripping member 24 functioning as a base for display purposes also provides an added benefit. The blade 115 is coupled within device 10 such that the blades 115 are held substantially perpendicular or transverse to support surface 25 of second gripping member 24. Because of this orientation of the blade 115, when second gripping member 24 is function as a base for display purposes, the blades 115 are not in contact with any other surface and protects the blade integrity, reduces any unsanitary environment of a tub or other surface that the blades may contact and prolongs the life of the blade. Further, as shown 6, body member 20 may include drain holes 27, wherein any water, soap and the like collected within body member 20 during use, may be drained out while device 10 is displayed using second gripping member 24 as the base. The drain holes 27 may be adjacent the second gripping member 24.

In some embodiments, graphics may be applied to outer surfaces of ergonomic device 10. These graphics may include a pad, laser etched, silkscreen printed, hand painted, and the like. Further, embodiments may include a texture on outer surfaces, such as, but not limited to rubber graphic design overlay or texture in the material of body member 20 of device 10, such as eyes, face, scales, wings clothing, art, logos and the like that operate as a design feature, but also provide additional function, such as, but not limited to an exfoliation surface. This texture may operate to improve gripping ability of device 10. Additionally, the body member 20 may be formed using other manufacturing means, such as but not limited to 3-D printing and the like.

The components defining any ergonomic device 10 may be formed of any of many different types of rigid or flexible materials or combinations thereof that can readily be formed into shaped objects provided that the components selected are consistent with the intended operation of an ergonomic shaving razor. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any ergonomic device 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An ergonomic device for holding a shaving razor comprising:
a body member having an ergonomic shape;
a first gripping member and a second gripping member, wherein the first and second gripping members are coupled on opposing sides of the body member; and
a blade receiving member coupled on an end of the body member, wherein the blade receiving member releasably receives and retains a blade.

2. The device of claim 1, wherein the second gripping member comprises a support surface, wherein the support surface provides a base for support and displaying the razor on a surface.

3. The device of claim 2, wherein the blade receiving member releasably retains the blade in a position transverse to the support surface of the second gripping member.

4. The device of claim 2, wherein displaying the razor on the support surface of the second gripping member retains the blade away from the surface supporting the razor.

5. The device of claim 1, wherein the blade is a disposable razor.

6. The device of claim 5, wherein the disposable razor comprises a shortened handle portion.

7. An ergonomic device for holding a shaving razor comprising:
a body member having an ergonomic shaped outer surface and a recess on an opposing side of the outer surface;
a first gripping member and a second gripping member, wherein the first and second gripping members are coupled on opposing sides of the outer surface of the body member;
a blade receiving member coupled on an end of the body member, wherein the blade receiving member releasably receives and retains a blade;
drain holes extending into the recess of the body member; and
a retaining member coupled to the body member, wherein the retaining member retains the container within the recess of the body member.

8. The device of claim 7, wherein the second gripping member comprises a support surface, wherein the support surface provides a base for support and displaying the device on a surface.

9. The device of claim 8, wherein the blade receiving member releasably retains the blade in a position transverse to the support surface of the second gripping member.

10. The device of claim 8, wherein displaying the device on the support surface of the second gripping member retains the blade away from the surface supporting the razor.

11. The device of claim 8, wherein displaying the device on the support surface of the second gripping member directs fluid within the body member through the drain holes.

12. The device of claim 11, further comprising a shaving skin preparation coupled within the recess of the body member.

13. The device of claim 12, wherein the retaining member comprises an aperture wherein the aperture provides access to the shaving skin preparation.

14. The device of claim 11, further comprising an exfoliating device coupled within the recess of the body member.

15. The device of claim 14, wherein retaining member comprises an aperture, wherein the aperture provides access to the exfoliating device.

16. The device of claim 12, wherein the shaving skin preparation is a solid skin preparation.

17. The device of claim 7, wherein the body member comprises a shape of an animal.

18. The device of claim 17, wherein the first gripping member, the second gripping member and the blade receiving member is have a shape corresponding to the animal shape of the body member.

19. The device of claim 7, wherein:
the body member includes an ergonomic fish shaped outer surface;
the first gripping member is shaped like a dorsal fin and the second gripping member is shaped like a pelvic fin; and
the blade receiving member is shaped like a tail.

20. An ergonomic device for holding a shaving razor comprising:
a body member having an ergonomic shaped outer surface and a recess on an opposing side of the outer surface;
a first gripping member and a second gripping member, wherein the first and second gripping members are coupled on opposing sides of the outer surface of the body member;
a blade receiving member coupled on an end of the body member, wherein the blade receiving member releasably receives and retains a disposable razor;
drain holes extending into the recess of the body member; and
a retaining member coupled to the body member, wherein the retaining member retains an exfoliating device within the recess of the body member.
